(19) United States
(12) Patent Application Publication
(10) Pub. No.: US 2007/0128508 A1
(43) Pub. Date: Jun. 7, 2007

(54) Battery structure

(76) Inventor: J.C. Fang, Tu-Cheng City (TW)

Correspondence Address: LIN & ASSOCIATES INTELLECTUAL PROPERTY, P.O. BOX 2339, SARATOGA, CA, 95070-0339, US

(21) Appl. No.: 11/287,073

(22) Filed: Nov. 23, 2005

(51) Int. Cl. H01M 2/10

(52) U.S. Cl. 429/100; 429/96

(57) ABSTRACT

A battery structure includes an out-can, an electrolyte contained in the out-can, a spiral-wound electrode assembly contained in the out-can and a sealed assembly provided at top end of the out-can. The spiral-wound electrode assembly includes a positive pole, a negative pole and a separator wound together spirally. Each of the positive electrode and the negative electrode penetrating the sealed assembly electrically connects with a positive pole and a negative pole respectively. The opened top end of the out-can is sealed by the sealing assembly. The positive pole and the negative pole penetrate the sealed assembly and expose to the out of out-can in same direction.

### BACKGROUND OF THE INVENTION

1. Field of the Invention

The present invention relates to an improved battery structure, and more particularly to a battery structure which can be easily soldered on a print circuit board (PCB) and is suitable for production processing.

2. The Related Art

In recent years, development and spread of various electrical machines and devices have been widely used with batteries, especially lithium battery as power sources thereof.

Generally, a conventional battery is shown in FIG. 4. The cylinder lithium battery 10aincludes an out-can 1a, an electrolyte (not shown in the figure), a spiral-wound electrode assembly 2a, two insulating board 25a, a positive connective wire 3a, a negative connective 4a, and a thermal resistance 6a and a battery lid 26a. The out-can 1a is closed at the bottom and opened at the top. The spiral-wound electrode assembly 2a includes a center pole 21a which is spirally winded by a positive electrode 22a, a negative electrode 23a and a separator 24a. The separator 24ais sandwiched between the positive electrode 22a and the negative electrode 23a. The assembly 2a is carried by the insulating board 25a. The positive conductive wire 3a electrically connects the positive electrode 22a with the thermal resistance 6a. So that, the battery lid 26a welded to the thermal resistance 6a electrically connects with the positive electrode 22a. The conductive wire 4a electrically connects the negative electrode 23a with the bottom of the out-can 1. Because this conventional battery electrodes are arranged in different direction, it is difficult to solder the battery structure to the PCB, and the battery structure is complicated to apply in manufacture.

FIG. 5 shows another battery structure. The battery structure includes an out-can 1b, a positive metal foil 2b, a negative conductive metal assembly 3b, an insulating board 4b and a PCB 5b. The out-can 1b has a positive electrode (not shown in the figure) and a negative electrode 21b. The positive foil 2b electrically connects the positive electrode of the out-can 1b with the positive electrode place 23b of the PCB 5b. The negative conductive metal assembly 3b electrically connects the negative electrode 21b of the out-can 1b with the negative electrode place 22b. The insulating board 4b separates the negative conductive metal assembly 3b and the PCB 5b. Although the positive electrode and the negative electrode are exposed to the same direction of the out can-1b in the battery structure, the production process is also complicated and the cost of production is expensive.

### SUMMARY OF THE INVENTION

The present invention is made in view of aforementioned problems and has an object to provide a battery structure which is simply to be manufactured.

To achieve the above object, the present invention provides a battery structure includes an out-can closed at the bottom end and opened at the top end, an electrolyte contained in the out-can, a sealed assembly provided at the top end of the out-can, and a spiral-wound electrode assembly contained in the out-can. The spiral-wound electrode assembly is formed by spirally winding a positive electrode, a negative electrode and a separator. The separator is sandwiched between the positive electrode and the negative electrode. Each of the positive electrode and the negative electrode penetrates the sealed assembly and electrically connects with a positive pole and a negative pole respectively, the opened top end of the out can is sealed by the sealed assembly, the positive pole and the negative pole penetrate the sealed assembly and expose to the out of the out-can in same direction.

According to the mentioned above, the battery structure of the present invention provides the exposed positive pole and negative pole to be easily soldered on a print circuit board (PCB) and is suitable for production processing.

### BRIEF DESCRIPTION OF THE DRAWINGS

The present invention will be apparent to those skilled in the art by reading the following description of embodiments thereof, with reference to the attached drawings, in which:

FIG. 1 shows a cross-sectional view of a first embodiment of a battery structure of the present invention;

FIG. 2 shows a partially enlarged view for the battery structure;

FIG. 3 shows a cross-sectional view of a second embodiment of the battery structure of the present invention;

FIG. 4 shows a cross-sectional view of a conventional battery structure; and

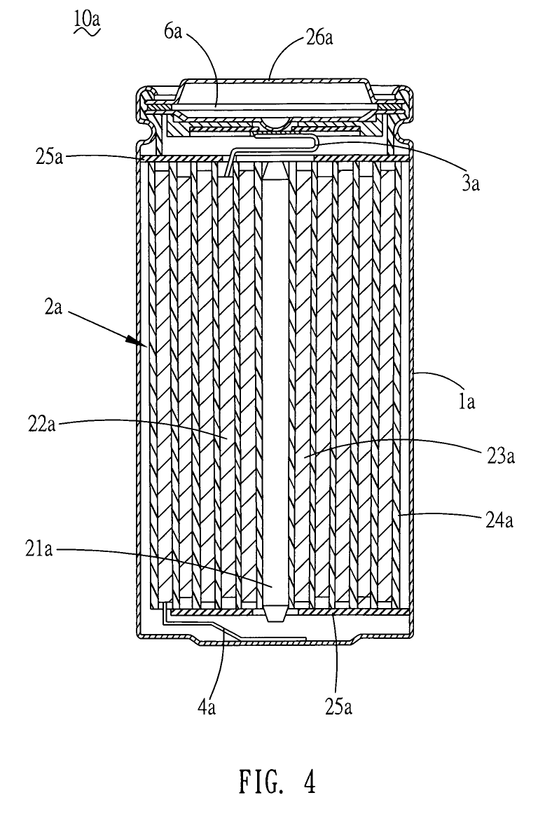

FIG. 5 shows an exploded view of another conventional battery structure to a conventional battery structure.

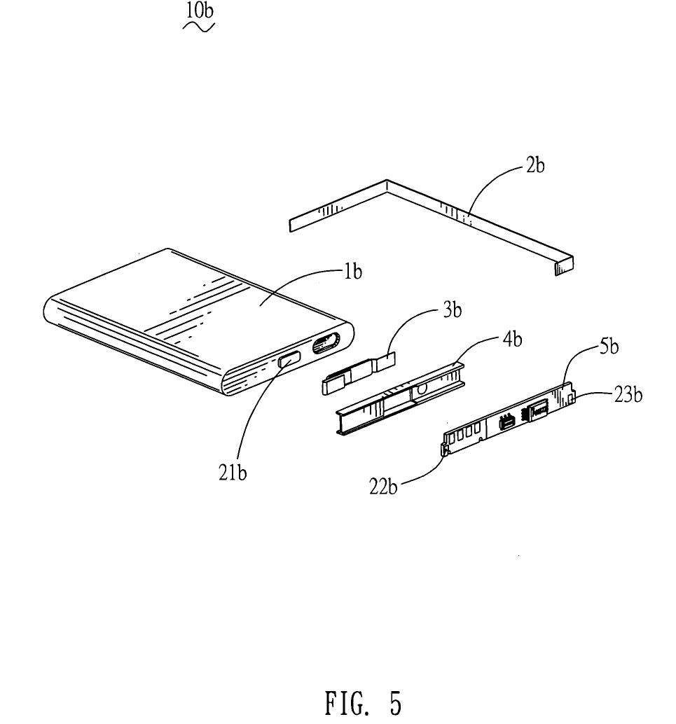

### DETAILED DESCRIPTION OF THE PREFERRED EMBODIMENTS

The battery structure according to the present invention will be described on the basis of the drawings.

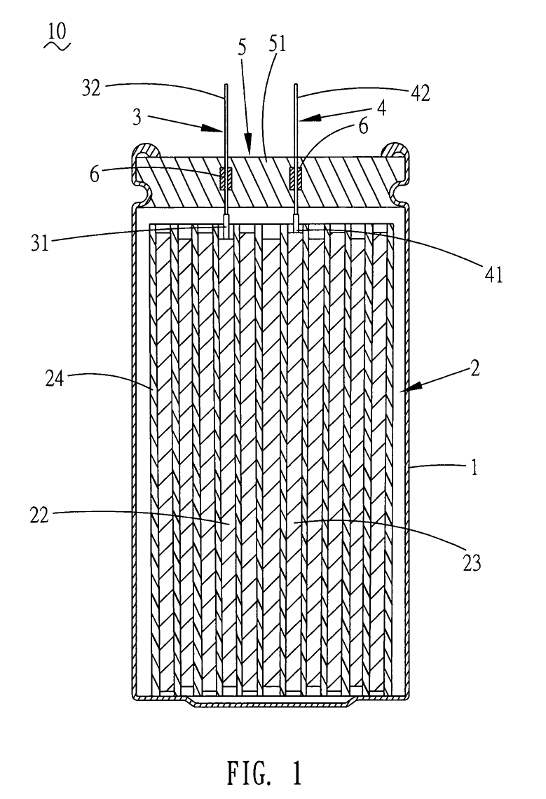

FIG. 1 is a cross-sectional view of a battery structure 10, such as a lithium battery structure. The battery structure 10 has an out-can 1 made of metal. The out-can 1 is in the shape of a cylinder closed at the bottom end and opened at the top end. The out-can 1 includes an electrolyte (not shown in the figure) and a spiral-wound electrode assembly 2. The electrolyte and the spiral-wound electrode assembly 2 are contained in the out-can 1. A sealed assembly 5 is provided at the top end of the out-can 1. The spiral-wound electrode assembly 2 is formed by spirally winding a positive electrode 22, a negative electrode 23 and a separator 24 which is sandwiched between the positive electrode 22 and the negative electrode 2. Each of the positive electrode 22 and the negative electrode 23 is electrically connected with a positive pole 3 and a negative pole 4 respectively. The positive pole 3 and the negative pole 4 penetrate the sealed assembly 5 and expose to the out of the metal out-can 1 in same direction. The sealed assembly 5 can be a sealing lid 51.

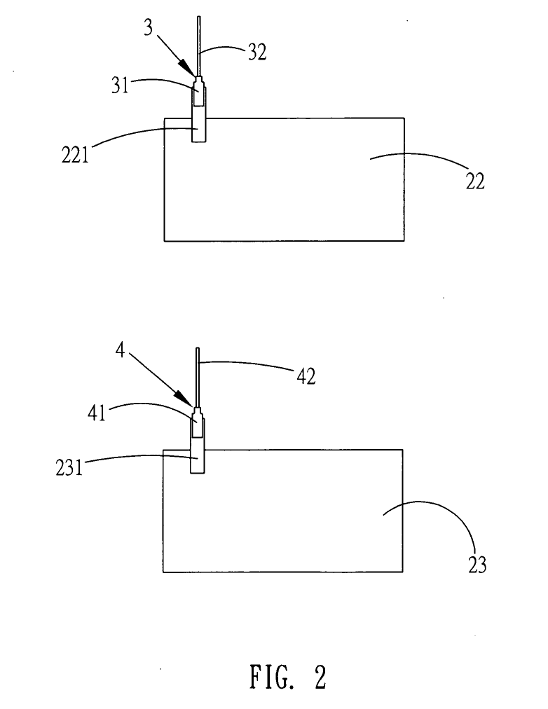

With reference to FIG. 2, each of the positive electrode 22 and the negative electrode 23 is made of copper foil. The positive electrode 22 has an aluminum electric conduction slice 221. The positive pole 3, which electrically connects with the positive electrode 22, includes an aluminum plate 31 welded to the positive electrode 221 and a tin-plated copper pole 32 welded to the top of the plate 31. The negative electrode 23 has a copper electric conduction slice 231. The negative pole 4, which electrically connects with the negative electrode 23, includes a copper plate 41 welded to the negative electrode 231 and a tin-plated copper pole 42 welded to the top of the plate 41.

To ensure the battery structure 10 safely used, each of the positive pole 3 and the negative pole 4 has a thermal resistor 6 to prevent the battery structure 10 from being damaged by short circuit current and overheating. The bottom surface of the out can 1 has a cross nick (not shown in the figure) used as a safety valve. If gas is produced abnormally in the out-can 1 and the internal gas pressure increases, the cross nick breaks down to discharge the gas pressure and avoids instantaneous explosion.

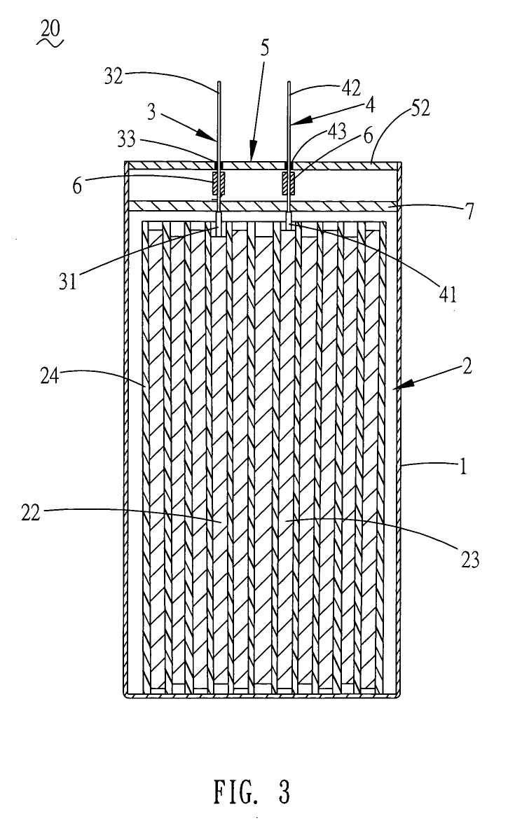

FIG. 3 shows a cross-sectional view of a lithium battery structure 20 of the second embodiment, The battery structure 20 has an out-can 1 made of aluminum. The out-can 1 is in the shape of a square closed at the bottom end and opened at the top end. The out-can 1 contains a spiral-wound electrode assembly 2 and an electrolyte (not shown in the figure). A sealed assembly 5 is provided at the top end of the out-can 1. The spiral-wound electrode assembly 2 is formed by spirally winding a positive electrode 22, a negative electrode 23 and a separator 24. The separator 24 is sandwiched between the positive electrode 22 and the negative electrode 23.

Each of the positive electrode 22 and the negative electrode 23 electrically connects with a positive pole 3 and a negative pole 4 respectively. The positive pole 3 and the negative pole 4 penetrate the sealed assembly 5 and expose to the out of the metal out-can 1 in same direction. The sealed assembly 5 can be a metal sealing lid 52. The method of bonding between the aluminum lid 52 and the metal out can 1 can be wheel welding, laser welding and so on. An insulating element 7 which is mounted at the top end of the out-can 1 separates the metal sealing lid 52 and the spiral-wound electrode assembly 2. The positive pole 3 and the negative pole 4 penetrate the insulating element 7 and the metal sealing lid 52. The metal sealing lid 52 has two insulating barrier 33 and 34. Each of the positive pole 3 and the negative pole 4 has been wrapped by the insulating barrier 33 and 43 in the aluminum lid 52 to avoid electrically connecting with the aluminum lid 52 respectively.

To ensure the battery structure 20 safely used, each of the positive pole 3 and the negative pole 4 of the second embodiment also has a thermal resistor 6 to prevent the battery structure 20 from being damaged by short circuit current and overheating. The bottom surface of the out-can 1 has a cross nick (not shown in the figure) used as a safety valve. If gas is produced abnormally in the out-can 1 and the internal gas pressure increases, the cross nick breaks down to discharge the gas pressure and avoids instantaneous explosion.

It is noted that the positive pole 3 and the negative pole 4 electrically connect with the positive electrode 22 and the negative electrode 23 respectively and expose to the out of the metal out-can 1 in same direction, therefore, the positive pole 3 and the negative pole 4 are easily soldered on the PCB and simply applied in manufacture. The battery structure of the present invention is suitable for small-sized hand-held device, such as a wireless headset.

While the present invention has been described with reference to special embodiments, therefore the description is illustration and is not to be constructed as limiting the invention. Various modifications to the present invention may be made to the preferred embodiments by those skilled in art without departing from the true spirit or scope of the invention as defined by the appended claim.

What is claimed is:

1. A battery structure comprising:
an out-can closed at the bottom end and opened at the top end;
an electrolyte contained in the out-can;
a sealed assembly provided at the top end of the out-can; and
a spiral-wound electrode assembly contained in the out can, the spiral-wound electrode assembly be formed by spirally winding a positive electrode, a negative electrode and a separator which is sandwiched between the positive electrode and the negative electrode;
wherein each of the positive electrode and the negative electrode penetrates the sealed assembly and electrically connects with a positive pole and a negative pole respectively, the opened top end of the out can is sealed by the sealing assembly, the positive pole and the negative pole penetrate the sealed assembly and expose to the out of the out-can in same direction.

2. The battery structure as claimed in claim 1, wherein the out can is in a shaped of a cylinder, and the top end of the out can is sealed by a sealing lid.

3. The battery structure as claimed in claim 1, wherein the out can is in a shaped of a square, and the top end of the out can is sealed by a metal sealing lid.

4. The battery structure as claimed in claim 3, further comprising an insulation element separating a metal sealing lid of the out-can and the spiral-wound electrode assembly.

5. The battery structure as claimed in claim 3, wherein the metal sealing lid has at least an insulating barrier, each of the positive pole and the negative pole has been wrapped by the insulating barrier in the metal sealing lid.

6. The battery structure as claimed in claim 1, wherein the positive electrode made of copper foil has an aluminum electric conduction slice.

7. The battery structure as claimed in claim 1, wherein the negative electrode made of copper foil has a copper electric conduction slice.

8. The battery structure as claimed in claim 1, wherein the positive pole includes an aluminum plate welded to the positive electrode and a tin-plated copper pole welded to the top of the aluminum plate.

9. The battery structure as claimed in claim 1, wherein the negative pole includes a copper plate welded to the positive electrode and a tin-plated copper pole welded to the top of the aluminum plate.

10. The battery structure as claimed in claim 1, wherein each of the positive pole and the negative pole has a thermal resistor.

11. The battery structure as claimed in claim 1, wherein the bottom surface of the out can has a cross nick.
